(19) United States
(12) Patent Application Publication
(10) Pub. No.: US 2010/0076965 A1
(43) Pub. Date: Mar. 25, 2010

(54) INFORMATION DISPLAY DEVICE, INFORMATION DISPLAY PROGRAM AND INFORMATION DISPLAY SYSTEM

(75) Inventors: Tomihisa Kamada, Tokyo (JP); Hiroyuki Suzuki, Yokohama (JP); Fumio Kawabata, Saitama (JP)

Correspondence Address: MORRISON & FOERSTER LLP, 425 MARKET STREET, SAN FRANCISCO, CA, 94105-2482, US

(73) Assignee: ACCESS CO., LTD., Chiyoda-ku (JP)

(21) Appl. No.: 12/515,737

(22) PCT Filed: Nov. 7, 2007
(86) PCT No.: PCT/JP2007/001223

§ 371 Date: May 20, 2009

(30) Foreign Application Priority Data
Nov. 20, 2006 (JP) 2006-313134

(51) Int. Cl. G06F 17/30; G06F 15/16

(52) U.S. Cl. 707/728; 707/E17.01; 709/203

(57) ABSTRACT

A weight processor 120 selects keywords that match a plurality of phrases extracted from an accessed file, from a keyword storage unit 110. The processor 120 determines a priority keyword based on the weights linked to the selected keywords. A useful information selector 150 selects useful information for use by the user and associated with the priority keyword, from a useful information storage unit. A feedback receiving unit 154 receives from the user an input for evaluation indicating whether user is interested in the content of the file. A weight adjusting unit 156 adjusts the weight linked to the keyword selected by the weight processor 120, based on the input evaluation, and records the adjusted weight in the keyword storage unit 110.

### TECHNICAL FIELD

The present invention relates to a technology of selecting information related to a file processed by an application program and presenting the information to the user.

### BACKGROUND ART

Web services are provided in which keywords or texts input or viewed by the user via a browser are referred to so that useful information, such as advertisements or web pages, that may be of interest to the user, are presented to the browser. For example, in a web searching site as shown in non-patent document 1, the user's input of a search keyword will display an advertisement relevant to the keyword in a browser along with the results of searching sites. In a web mail service as shown in non-patent document 2, a text advertisement and a link to a web page of high relevance to a mail message are displayed beside the mail message.

### Non-Patent Document 1:

Advertise your business on Google, [online], [retrieved on 2006 Nov. 16], Internet <URL:https://adwords.google.com/select/Login>

### Non-Patent Document 2:

About Gmail, [online], [retrieved on 2006 Nov. 16], Internet <URL:http://mail.google.com/mail/help/more.html#ads>

### DISCLOSURE OF THE INVENTION

### Problem to be Solved by the Invention

In the web services shown in the above-mentioned non-patent documents 1 and 2, useful information, relevant to the keyword which the user inputted at the web searching site at that time, or the keyword contained in the mail message being viewed by the user in the web mail service, is presented. However, the history of searches or e-mail viewing by the same user or the degree of user's interest in keywords is not reflected in retrieval of useful information. Therefore, useful information less interesting to the user is in fact presented in many cases.

In this background, a purpose of the present invention is to provide a technology capable of receiving feedback for evaluation of an opened file from the user and modifying a keyword condition for searching for a document related to the file in accordance with the result of evaluation.

### Means to Solve the Problem

One embodiment of the present invention relates to an information display apparatus. The apparatus comprises: an access processor operative to process a file access designated by a user; a phrase extractor operative to extract a plurality of phrases from a file subjected to the file access, in accordance with a predetermined extraction rule; a keyword storage unit operative to store a plurality of keywords, linking the keywords to weights; a useful information storage unit operative to store a plurality of items of useful information for use by the user, in association with keywords related to the content of the information; a weight processor operative to select, when the plurality of phrases are extracted from the file, keywords that match the plurality of phrases from the keyword storage unit and to determine a priority keyword based on the weights linked to the selected keywords; a useful information selector operative to select the useful information associated with the priority keyword from the useful information storage unit and to display the selected information on a screen; a feedback receiving unit operative to receive from the user an input for evaluation indicating whether user is interested in the content of the file; and a weight adjusting unit operative to adjust the weight linked to the keyword selected by the weight processor, based on the input evaluation, and to record the adjusted weight in the keyword storage unit.

The term “useful information” in this case refers to information which creates certain value for the user of a device and encompasses what can be reproduced in an information terminal (e.g., documents, images, sound, etc.).

The term “file” encompasses document files such as ordinary text files, HTML files or XML files described in a markup language, e-mail files, cache, temporary files, etc. In the case of e-mail files, the term encompasses a single file associated with a single mail message but also a single file containing all mail messages in a folder (e.g., a received message folder of an e-mail program).

According to the embodiment, evaluation as to whether the user is interested in a file is received from the user and keywords extracted from the file are weighted according to the evaluation. The keywords thus weighted are used as a reference to select useful information presented to the user in association with the file. Since the keywords are weighted in a manner reflecting the user preference, the likelihood of selecting useful information suited to the user preference is increased. Since the weight of a keyword extracted from a file is adjusted according to the evaluation given to the file as a whole, the time-consuming process of evaluating each and every keyword is not needed.

When it is determined that the user does not provide an input for evaluation before a predetermined trigger occurs, the weight adjusting unit does not adjust the weight. The term “predetermined trigger” refers to something that lets the device to stop waiting for the input from the user. For example, the passage of time, user operation, file process initiated by an application program, etc. may enforce the termination. This allows the weight to be adjusted only when there is an explicit input from the user, thereby preventing inappropriate weight adjustment from being taking place due to the lack of user interest in the input.

The information display apparatus may further comprise: a predictive evaluation unit operative to determine whether the user is interested in the content of the file, in accordance with a sum of weights linked to the keyword that matches the extracted phrase, and to output a result of prediction indicating the interest or non-interest; and a display controller operative to display on the screen a mark that lets the user know the result of prediction by the predictive evaluation unit. In this case, the feedback receiving unit may display a mark prompting the user to respond to indicate whether the prediction result matches the user evaluation and may receive a user input in response. When the user enters a response, the weight adjusting unit may adjust the weight linked to the keyword according to the response.

According to this approach, prediction of the evaluation of a file is displayed according to the weight of a keyword, prior to the user evaluation. When the prediction result matches the user evaluation, the user does not need to enter the evaluation so that the trouble is saved.

When it is determined that the user does not provide an input in response before a predetermined trigger occurs, the weight adjusting unit may adjust the weight linked to the keyword based on the result of prediction by the predictive evaluation unit. According to this approach, a determination is made that the prediction result matches the user evaluation in the absence of user response, and the weight of the keyword is adjusted according to the prediction result.

The keyword storage unit separately may store a positive weight and a negative weight for each keyword, the positive weight being incremented when it is determined that a positive evaluation of the content of the file is given by the user, and the negative weight being incremented when it is determined that a negative evaluation is given by the user. By storing both positive and negative weights for each keyword, positive weights and negative weights can be tallied separately from each other. This prevents conflicting evaluations from being mixed, enabling the selection of useful information suited to the user preference.

The predictive evaluation unit may comprise: a weight adder unit operative to calculate a sum of positive weights linked to each keyword that matches the phrase extracted from the file and also a sum of negative weights thus linked; and an evaluation determination unit operative to determine whether the user is interested in the content of a file depending on the relative magnitude of the sums of positive and negative weights. By adding up, for each keyword, positive weights and negative weights assigned to the keyword, predictive evaluation of a file can be made in a simplified fashion.

The weight processor may select, as a priority keyword, a keyword linked to a positive weight that exceeds a negative weight. In this way, keywords included in a positively evaluated file a relatively larger number of times are selected as priority keywords. This facilitates selection of useful information suited to the user preference, by using priority keywords.

The keyword storage unit may discount the weights stored in association with the keywords with the passage of time. In this way, the weight assigned to the keywords included in a file recently referred to will carry more weight than those included in a file referred to in the past. Accordingly, those keywords suited to the user preference are more likely to be selected.

The information display apparatus may further comprise a history storage unit operative to store the history of user evaluation of the content of the file. In this case, the feedback receiving unit may refer to the history stored in the history storage unit and, when the evaluation different from the past tendency of evaluation is entered by the user, display a mark prompting the user for confirmation of the evaluation. By prompting for reconfirmation in the event of sudden change in the evaluation, errors in the user evaluation are avoided

When the file subjected to file access is detected, by means of a certain method of detection, as being of a type for which valid user evaluation would be difficult to derive, the weight processor may avoid the selection of keywords from the keyword storage unit. The term “file of a type for which valid user evaluation would be difficult” refers to a file that does not include keywords that help derive useful information (e.g., files containing numerals and symbols for the major part, or files where words not related to each other are listed). Since it will be difficult to select useful information for such files, selection of keywords is avoided.

The weight adjusting unit may record a weight determined by the situation of access to the file by the access processor in the keyword storage unit, in addition to the weight based on the user evaluation of the content of the file. The importance of a file differs depending on the situation of access to the file. For example, the importance of a file to the user is considered to be different in the case that the file is merely viewed and in the case that the file is updated and saved. By assigning a weight determined by the situation of access to the file, useful information associated with more important keywords can be presented to the user.

Optional combinations of the aforementioned constituting elements, and implementations of the invention in the form of methods, apparatuses, systems, recording mediums and computer programs may also be practiced as additional modes of the present invention.

### ADVANTAGE OF THE PRESENT INVENTION

According to the present invention, feedback for evaluation of an opened file is received from the user, and the weight of a keyword for deriving useful information is adjusted accordingly. Therefore, the likelihood of presenting useful information to the user is increased.

### BRIEF DESCRIPTION OF THE DRAWINGS

FIG. 1 shows the entire configuration of a network system including a portable information device provided with an information display function according to an embodiment;

FIG. 2 shows the hardware configuration of the portable information device;

FIG. 3 shows the configuration of those parts of the information display device related to an information display unit according to the embodiment;

FIG. 4 shows a table listing examples of keywords and weights stored in the keyword storage unit;

FIG. 5 shows an example of text included in a file from which keywords are extracted;

FIG. 6 shows a table listing examples of useful information stored in the useful information storage unit;

FIG. 7 shows how useful information is displayed by a display controller by way of example;

FIG. 8 shows weights of keywords adjusted by a weight adjusting unit;

FIG. 9 is a flowchart showing the process of presenting useful information and weighting keywords according to the first embodiment;

FIG. 10 shows an information display apparatus according to the second embodiment;

FIG. 11 is a flowchart showing the process performed in the information display apparatus to present useful information and to weight keywords for selection of useful information;

FIG. 12 shows how a result of evaluation by a predictive evaluation unit is displayed on a display along with an application screen;

FIG. 13 is a flowchart showing the process of presenting useful information and weighting keywords according to the second embodiment;

FIG. 14 is a flowchart showing the process of avoiding selection of keywords;

FIG. 15 shows an example of evaluation history stored in a history storage unit; and

FIG. 16 is a functional block diagram showing the structure of a file access based adder unit.

### DESCRIPTION OF THE REFERENCE NUMERALS

10 portable information device, 12 server, 100 information display unit, 102 file storage unit, 104 access processor, 106 phrase extractor, 110 keyword storage unit, 120 weight processor, 122 keyword selector, 124 priority keyword determination unit, 130 useful information storage unit, 150 useful information selector, 152 display controller, 154 feedback receiving unit, 156 weight adjusting unit, 158 evaluation storage unit, 160 predictive evaluation unit, 162 weight adder unit, 164 evaluation determination unit, 170 file access based adder unit

### BEST MODE FOR CARRYING OUT THE INVENTION

### First Embodiment

The first embodiment is directed to using an operating system (OS) for portable information devices to monitor access from an application program to a file, extracting a plurality of keywords from the file, and displaying useful information (e.g., advertisement corresponding to the keyword) on the screen of the portable information device. This enables deriving useful information suited to the interest of the user of the portable information device via keywords included in the accessed file.

A general explanation of the portable information device will be given first, followed by a detailed explanation of an information display apparatus according to the first embodiment.

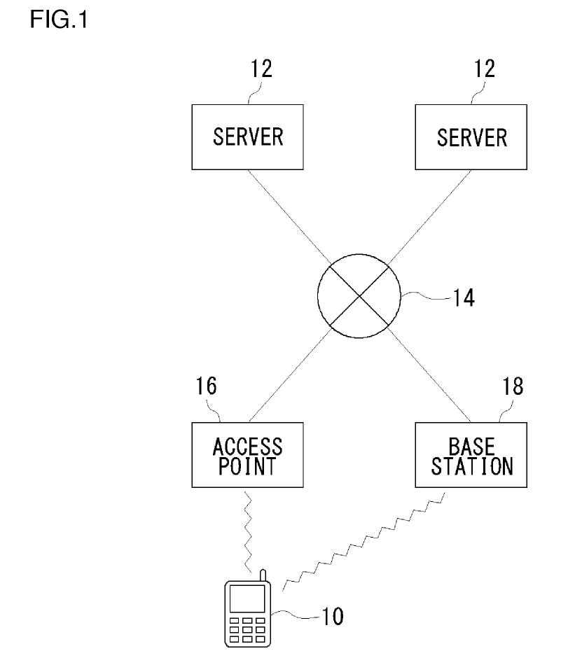

FIG. 1 shows the overall configuration of a network system including a portable information device 10 provided with an information display function according to this embodiment.

The portable information device 10 may be any hardware movable with the user, such as a laptop PC (personal computer), PDA, cellular phone, and car navigation device provided with communication functions. The portable information device 10 is connected by the user's operation to a network 14, such as a LAN and the Internet, via an access point 16 or a base station 18, and is capable of accessing a server 12 specified by a URL and of acquiring desired data.

The server 12 provides the portable information device 10 with data such as text data, image data, audio data, video data, etc. via the network 14. The server may be a service entity on the Internet such as a web server. In that case, the invention may be implemented in various modes including: a mode embodied, for example, by a Common Gateway Interface (CGI) in which the server side takes care of the major processing functions; a mode embodied by, for example, a Java (registered trademark) applet in which the major processing functions are shifted to the client side; and a mode of Application Program Interface (API) type in which the main processing functions (e.g., Java applications) are distributed both to a server and a client.

The portable information device 10 is configured so that it can refer to and edit a file stored in an internal storage or a storage medium by the user's operation, even if the device does not access the network 14.

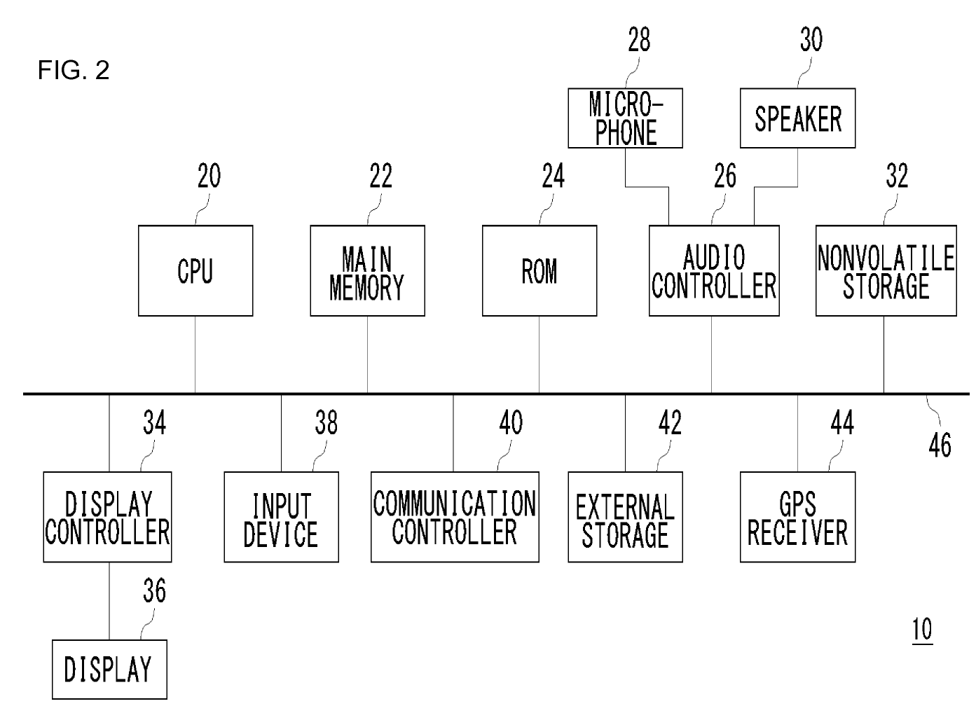

FIG. 2 shows the hardware configuration of the portable information device 10. The portable information device 10 is provided with a CPU 20, a main memory (RAM) 22, a ROM 24, an audio controller 26, a nonvolatile storage 32, a display controller 34, an input device 38, a communication controller 40, an external storage 42, and a GPS receiver 44. These are mutually connected via a bus 46.

The CPU 20 runs an operating system and controls the entire portable information device 10. The CPU 20 also reads into the main memory 22 a program and data from the ROM 24 or the recording medium loaded into the external storage 42, and performs various kinds of processing accordingly. The main memory 22 serves as a temporary storage and a work area which is needed when the CPU 20 executes the program, and as an area which stores various kinds of data required for program execution. The ROM 24 is a read-only storage which stores a computer program and data processed by the CPU 20.

The audio controller 26 is provided in the portable information device such as a cellular phone provided with a telephone function and is connected with a microphone 28 and a loudspeaker 30 for audio input output control.

The nonvolatile storage 32 is a storage capable of retaining the memory content even after power OFF, and may be a hard disk drive or a semiconductor memory such as a flash memory.

The display controller 34 generate a video signal for displaying the data drawn by the CPU in a frame buffer (not shown) on a display 36 provided in the portable information device 10.

The input device 38 is a device for the user to provide directions for operation to the portable information device 10. The input device 38 may be any device suited to the terminal. For example, the device may be: keys; a pointing device like a trackpad; buttons; and a touch panel provided on the surface of the display 36. A mouse may be connected to the portable information device via, for example, a universal serial bus (USB) terminal.

The communication controller 40 controls communication of sound and data by various communication schemes. The data communication scheme may be wireless LAN such as IEEE802.1b/g, infrared communication, or data communication such as packet communication. The portable information device 10 may be connected to the network 14 using a cable.

The external storage 42 is a drive device which uses a removable recording medium. The recording medium may be a magnetic disk, an optical disk, a magneto-optical disc, or a semiconductor memory.

The GPS receiver 44 is a device which locates the portable information device based on radio wave from a satellite.

Since the constituting elements described above are all well known, a description of further details will be omitted.

Characteristically, a substantial amount of data referred to by the user is temporarily stored in a file. Files for received mail and cache files of a browser, etc. are referred to repeatedly. Thus, when the user refers to a file accessed frequently, it will be very useful to present to the user an advertisement or news relevant to the file, update information of a related website, etc.

In this background, the first embodiment provides a scheme of selecting information useful for the user and presenting the selected information. The first embodiment also provides a scheme for adjusting the method of searching for useful information so that information truly needed by the user is presented.

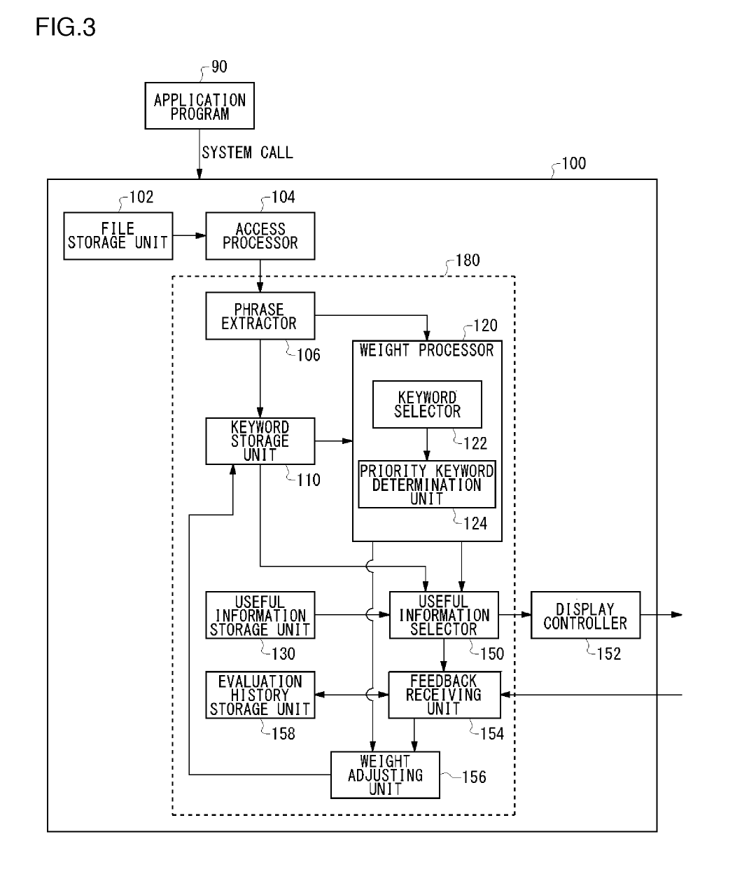

FIG. 3 shows the configuration of an information display unit 100, which is a part of the portable information device 10, wherein presentation of information is based on a file operation. The configuration is implemented in hardware by any CPU of a computer, a memory or other LSI's, and in software by a program or the like loaded into the memory. FIG. 3 depicts functional blocks implemented by the cooperation of hardware and software. Therefore, it will be obvious to those skilled in the art that the functional blocks may be implemented in a variety of manners including hardware only, software only, or a combination thereof.

Preferably, the information display unit 100 according to this embodiment is implemented by a part of an operating system. An operating system has various functions, such as process control, memory management, device management, and GUI. Of those functions implemented by the combination, FIG. 3 illustrates only those which pertain to this embodiment. The portion enclosed with the dashed line in FIG. 3 shows the functional block added to the operating system for realization of this embodiment. Those functions provided in a common operating system are of course provided even if they are not shown in FIG. 3.

Before explaining each functional block in detail, the outline of the entire operation is explained.

When a system call for file access is issued from an application program 90, an access processor 104 selects from a file storage unit 102 a file specified by the system call, and performs a file access. A phrase extractor 106 extracts a plurality of phrases from the file in accordance with a predetermined extraction rule. A keyword selector 122 selects, from the keywords stored in a keyword storage unit 110, keywords that match the phrases extracted by the phrase extractor 106. A priority keyword determination unit 124 determines a priority keyword from the selected keywords in accordance with the weight associated with the keywords. The useful information selector 150 selects the useful information associated with the priority keyword from the useful information storage unit 130. The display controller 152 displays the useful information on the display 36 of the portable information device 10.

A feedback receiving unit 154 receives the user evaluation of the file that the access processor is processing, i.e., the file displayed on the display. A weight adjusting unit 156 adjusts the weight of the keyword extracted from the file according to the user evaluation and overwrites the keyword storage unit 110 accordingly.

Details of the operation and configuration of the functional blocks will now be described.

The file storage unit 102 holds a plurality of files read by various kinds of applications. A document file is defined as primarily containing text information. Examples of document files include a document-based file, a hypertext markup language (HTML) file, a PDF file, a presentation file, and a spreadsheet file. Files may be acquired via a network or stored in the storages 32 and 42 of the portable information device 10.

When a system call for file access is issued from any of a plurality of application programs 90, the access processor 104 selects from the file storage unit 102 the file specified by the system call. The processor then accesses the file designated by the system call. The file access process specified by a system call includes opening and closing, writing, deletion, etc. of a file. As a result of the file access by the access processor 104, a screen showing the execution of the file by the application program is displayed on the display 36 of the portable information device 10.

The phrase extractor 106 acquires the file which is designated by the system call and which is the target of file access by the access processor 104. The extractor then extracts a plurality of phrases from the text data contained in the file. The extraction is performed in accordance with a predefined extraction rule. For example, the phrase extractor 106 performs the known steps of morphological analysis on the text data and divides the data into morphemes, followed by counting the frequency of occurrence of each phrase within the file. The unit then extracts a characteristic phrase. The term “characteristic phrase” refers to a phrase by which a part of information (e.g., the content and property of a file) can be estimated. A predetermined number of those phrases with the highest frequency of occurrence may be designated as characteristic phrases. Alternatively, characteristic phrases may be extracted by a well-known Term Frequency (TF) method whereby a weight based on the frequency of occurrence within a file is applied. Still alternatively, characteristic phrases may be extracted by an Inverse Document Frequency (IDF) method whereby data for phrases with higher frequency of occurrence in ordinary sentences are registered in the phrase extractor 106, so that phrases that appear frequently in any sentences are assigned a low weight, and phrases that are unique to the sentence are extracted so as to highlight its uniqueness. The TF/IDF method, which is a combination of the TF method and the IDF method, may be used.

A large number of keywords of low value will be held in the keyword storage unit 110 if the phrases extracted by the phrase extractor 106 are too many. Therefore, it is preferable to ensure that ten or fewer characteristic phrases are extracted. However, the number of characteristic phrases extracted from a single file is not limited. Any number of phrases can be extracted.

The keyword storage unit 110 links keywords with weights and stores the association for each keyword. A fixed keyword group may be stored. Alternatively, each a phrase is extracted by the phrase extractor 106 as a characteristic phrase, the extracted word may be added as a new keyword.

Preferably, the keyword storage unit 110 separately stores a positive weight and a negative weight for each keyword. A positive weight is incremented for a keyword included in a file when it is determined that the user gives a positive evaluation of the file content. A negative weight is incremented for a keyword included in a file when it is determined that a negative evaluation is given. A detailed description of user evaluation of the file content will be given later in relation to the feedback receiving unit 154.

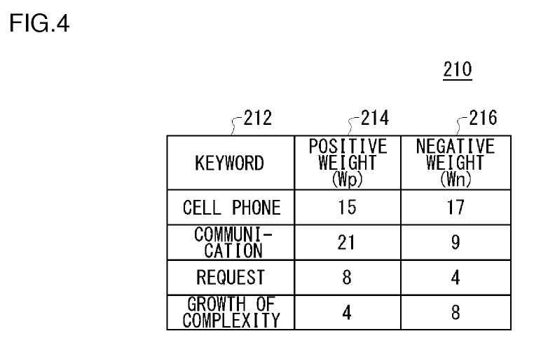

FIG. 4 shows a table 210 listing examples of keywords and weights stored in the keyword storage unit 110. A column 212 lists keywords stored in the table. FIG. 4 shows that “cell phone”, “communication”, “request”, “growth of complexity” are stored as keywords. A column 214 lists positive weights Wₚ linked to the keywords of the column 212. A column 216 lists negative weights Wₙ linked to the keywords. There may be only one type of weight linked to the keywords.

Referring back to FIG. 3, a weight processor 120 is provided with a keyword selector 122 and a priority keyword determination unit 124.

The keyword selector 122 selects, from the group of keywords stored in the keyword storage unit 110, a keyword that matches the characteristic phrase extracted by the phrase extractor 106 from a file. The priority keyword determination unit 124 determines one or a plurality of priority keywords from the selected keywords in accordance with the weight associated with the keywords. A priority keyword is defined as a keyword referred to when selecting useful information as described later.

The priority keyword determination unit 124 may identify a priority keyword, when the positive weight linked to the keyword exceeds a predetermined threshold value. Alternatively, all keywords may be arranged in the descending order of positive weight so that a predetermined number of keywords with larger weights are selected as priority keywords. Alternatively, the priority keyword determination unit 124 may identify a priority keyword when the positive weight linked to the keyword exceeds the negative weight.

When only one type of weight is linked to the keywords, keywords linked to a weight exceeding a threshold value may be designated as priority keywords. Alternatively, the keywords may be arranged in the descending order of weight so that a predetermined number of keywords with larger weights are designated as priority keywords.

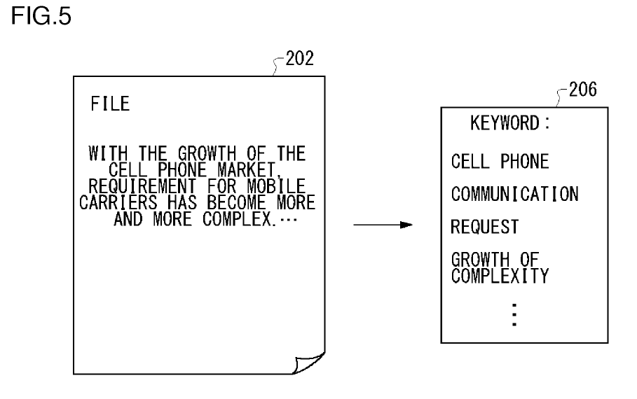

As shown in FIG. 5, it will be assumed by way of example that a text 202 is included in a file opened by the application processor 104. The phrase extractor 106 extracts a plurality of phrases from the text 202 by morphological analysis. Subsequently, the keyword selector 122 performs a matching operation between the extracted phrases and the keywords in the table 210 in the keyword storage unit 110 shown in FIG. 5. As a result, a keyword group 206 including four keywords “cell phone”, “communication”, “request”, “growth of complexity”, which are included in the table 210, are selected. The priority keyword selector 124 may compare the positive weights Wₚ of these keywords and determine “communication”, which gives the maximum value, as a priority keyword. When a keyword with a positive weight that exceeds the negative weight should be designated as a priority keyword, the priority keyword determination unit 124 determines “communication” and “request” as priority keywords. When a keyword with positive weight that exceeds a threshold value (e.g., 10) should be designated as a priority keyword, the priority keyword determination unit 124 determines “cell phone” and “communication” as priority keywords.

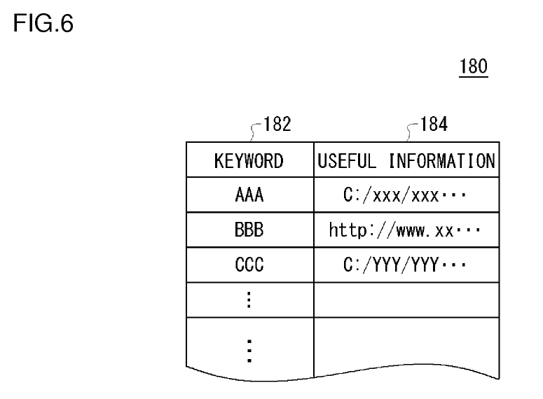

Referring back to FIG. 3, the useful information storage unit 130 stores a plurality of items of useful information for use by the user, in association with keywords related to the content of the information. Examples of useful information include an advertisement, URL of a web page, URL of a blog, help, and news. FIG. 6 shows a table 180 listing examples of useful information stored in the useful information storage unit 130. A column 184 lists addresses indicating the location of storage of useful information that should be presented to the user. A column 182 lists keywords for deriving the useful information of the column 184. A plurality of keywords may be defined for a single item of useful information.

When the keywords stored in the keyword storage unit 110 are fixed, the useful information corresponding to the keywords may be stored in the useful information storage unit 130 before shipping the portable information device 10. Alternatively, periodically updated useful information may be acquired from the server 12 accessed by the portable information device 10. In case that phrases extracted by the phrase extractor 106 are added one after another to the keyword storage unit 110, a large number of combinations between keywords and useful information may be prepared in the server 12, so that, when a new keyword is added, the portable information device 10 may access the server 12 to acquire useful information corresponding to the keyword. In presenting an advertisement, news, web site information, or the like as useful information, the freshness of information counts. Therefore, it is preferable to download useful information from the server as needed.

The useful information selector 150 receives a priority keyword from the weight processor 120 and selects useful information corresponding to the priority keyword from the information stored in the useful information storage unit 130. The selected useful information is delivered to the display controller 152.

When the useful information storage unit 130 stores a combination of a plurality of keywords and useful information mapped into each other, the useful information selector 150 selects useful information corresponding to a plurality of priority keywords. For selection of useful information based on a plurality of keywords, a well-known vector search technique may be used. By selecting useful information based on a plurality of keywords, the probability of presenting useful information that matches the user's interest is increased.

At an early stage when the keyword storage unit 110 stores only a few keywords assigned a weight, the same useful information may continue to be presented. Therefore, useful information may be prevented from being displayed until the number of keywords assigned a weight reaches a predetermined value.

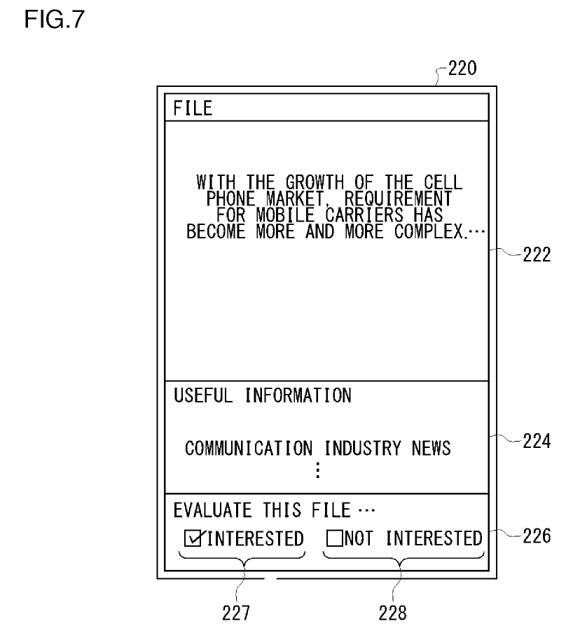

The display controller 152 displays the useful information output from the useful information selector 150 on a screen 220 of the display. FIG. 7 shows how useful information is displayed by the display controller 152 by way of example. The display controller 152 displays the useful information in a separate window 224, superimposing the window 224 on a window 222 for displaying the file opened by the application program. When an area for displaying useful information is available in the screen created by the application program, the display controller 152 may deliver the useful information to the application program so as to let the program create a screen that includes the useful information.

Subsequently, the feedback receiving unit 154 receives from the user an input for evaluation indicating whether user is interested in the content of the file originating the useful information.

The input for evaluation is received for the following reasons. Whether the useful information is of any significance to the user depends on how proper useful information is retrieved from the useful information storage unit 130 based on the file processed by the access processor 104. For this purpose, keywords that will help derive useful information that is of advantage to the user needs to be determined to be priority keywords.

The first embodiment is based on our findings that, when a currently opened file is of high interest to the user, the keywords included in such a file include those of high importance in selecting useful information. More specifically, keywords included in files of high interest to the user and those included in files of low interest are collected respectively and weighted accordingly. The weights assigned to keywords extracted from another file opened are compared one another so as to determine priority keywords accordingly.

As shown in FIG. 7, the feedback receiving unit 154 displays a window 226 for receiving the input for evaluation indicating whether the user is interested in the file, below the window 222 for the file and the window 224 for the useful information. Checkboxes 227 and 228 for “Interested” and “Not interested” are displayed in the window 226. When the user checks one of the boxes, the feedback receiving unit 154 acquires the information.

Instead of displaying the window 226, buttons (not shown) provided in the portable information device 10 may be assigned the task of receiving the input for evaluation indicating “Interested” or “Not interested”. When one of the buttons is activated, the feedback receiving unit 154 acquired the information.

The terms “Interested” and “Not interested” as used in this specification indicate whether the user generally gives a positive evaluation or negative evaluation to the file content based on certain criteria. Thus, the terms “Interested” and “Not interested” may be replaced without limitation by any expression (e.g., “I like it” and “I don't like it”, “Attracted” and “Not attracted”, or “Positively viewed” and “Negatively viewed) that gives relative evaluation based on certain criteria.

The choice may not be between the two, and more detailed evaluation may be given. For example, four scores of evaluation including “Very interested”, “Slightly interested”, “Little interested”, and “Not interested at all” may be provided, allowing the user to select one of them.

Alternatively, the user may be allowed to enter a numerical value indicating the degree of interest. For example, the user may be allowed to enter any of numerals 1-5, where “5” indicates the highest interest and “1” indicates the lowest interest.

Referring back to FIG. 3, the weight adjusting unit 156 adjusts the weight linked to the keyword selected by the weight processor 120, based on the evaluation entered by the user. The unit 156 records the adjusted weight in the keyword storage unit 110. More specifically, the evaluation “Interested” increments the positive weight. The evaluation “Not interested” increments the negative weight.

When it is determined that the user does not provide an input for evaluation before a predetermined trigger occurs, the weight adjusting unit 156 may not adjust the weight. This is to prevent the absence of explicit user evaluation from being reflected in the result.

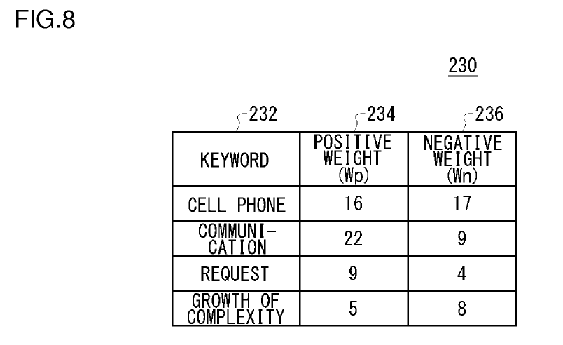

FIG. 8 shows a table 230 showing the weights of the keywords adjusted by the weight adjusting unit 156. It is assumed that the keyword group 206 shown in FIG. 5 is extracted from the file and the user checks the check box 227, indicating that the user is “Interested” in the file. The weight adjusting unit 156 receives the currently selected keyword group from the weight processor 120, uniformly increments the positive weights Wₚ, linked to the keywords of the column 232, by “1” before storing the keywords with the adjustment in the keyword storage unit 110. Thus, FIG. 8 shows that the positive weights in a column 234 are larger than the positive weights of the column 214 of FIG. 4 by 1. Conversely, when the user checks the box to indicate that the user is “Not interested” in the file, the weight adjusting unit 156 uniformly increments the negative weights Wₙ in a column 236 by “1” before storing the keywords in the keyword storage unit 110.

In case one of three or more scores of evaluation (e.g., “Very interested”, “Slightly interested”, “Little interested”, and “Not interested at all”) is selected by the user, the increment of the positive weight or negative weight may be varied depending on the score. For example, for the scores “Very interested” and “Slightly interested”, the positive weight may be increased by increments of “2” and “1”, respectively. For the scores “Little interested” and “Not interested at all”, the negative weight may be increased by “1” and “2”, respectively.

In case the evaluation is indicated by entering a numerical value, the positive weight or negative weight may be variably incremented depending on the numerical value.

Thus, according to the first embodiment, the weights of all keywords in the keyword group selected from a file are incremented depending on the result of evaluation of the file.

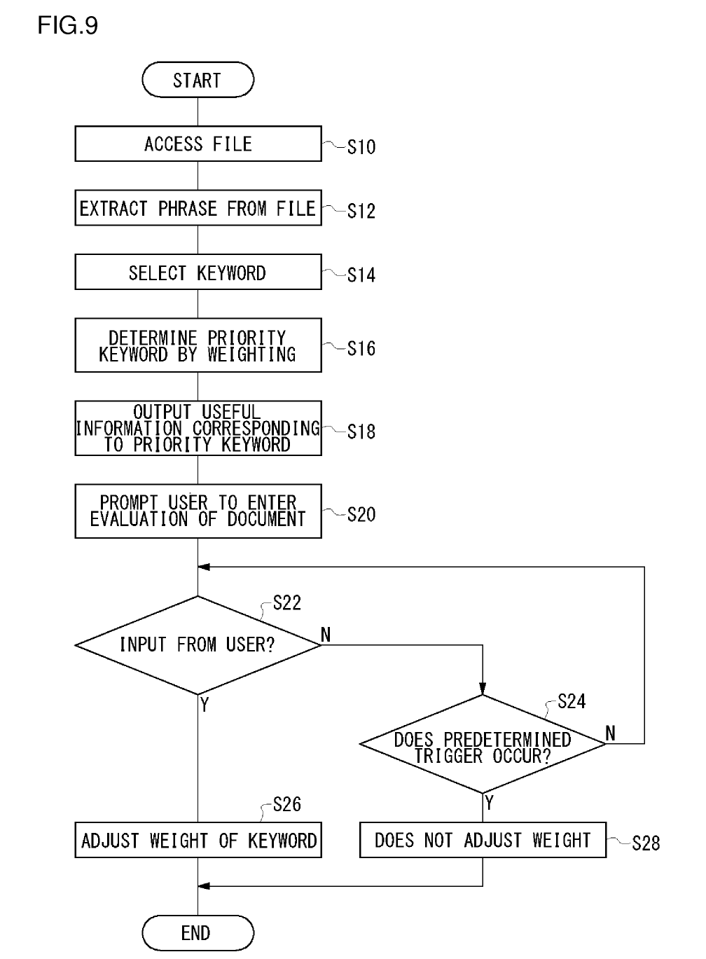

FIG. 9 is a flowchart showing the process performed in the information display unit 100 to present useful information and to weight keywords.

When a system call is issued from an application program to the operating system, the access processor 104 accesses a file designated by the system call (S10). The phrase extractor 106 acquires the file accessed by the access processor 104 and extracts phrases from the text data included in the file in accordance with a predetermined extraction rule (S12).

The weight processor 120 acquires from the keyword storage unit 110 those keywords that match the phrases extracted by the phrase extractor 106 (S14). Subsequently, the weight processor 120 determines a priority keyword based on the weights linked to the selected keywords (S16). The priority keyword is delivered to the useful information selector 150. The useful information selector 150 acquires the useful information mapped into the priority keyword from the useful information storage unit 130 and outputs the information accordingly (S18).

Subsequently, the display controller 152 displays a screen that lets the user to indicate whether the user is interested in the file currently displayed on the display and prompts the user to enter the evaluation (S20). This could be achieved by, for example, displaying an input screen with a message such as “Please indicate your interest in the file”. Alternatively, only an input screen may be displayed so that only the user that noticed the screen may respond. Thus, the first embodiment does not require receiving the evaluation of useful information retrieved as a result of the search but requires receiving from the user the evaluation of the file from which the keyword for retrieving useful information is derived.

When the user enters evaluation in S20 (Y in S22), the feedback receiving unit 154 receives the information. The weight adjusting unit 156 adjusts the positive and negative weights of all keywords selected by the weight processor 120 in accordance with the input (S26).

When the user does not enter evaluation in S22 (N in S22), the feedback receiving unit 154 determines whether a predetermined trigger occurs (S24). The term “predetermined trigger” refers to something that lets the device to stop waiting for the input from the user. For example, the passage of time, user operation, file process initiated by an application program, etc. may be a trigger. In the absence of a predetermined trigger (N in S24), the control is returned to S22, whereupon the device waits for an input from the user. When a predetermined trigger occurs (Y in S24), the feedback receiving unit 154 directs the weight adjusting unit 156 not to adjust the weights of the keywords (S28).

As described above, according to the first embodiment, keywords are extracted from a file accessed, useful information is presented to the user based on the keywords, and the user evaluation of the file is received. The weights of the keywords extracted from the file are adjusted according to the evaluation. The keywords thus weighted are used as a reference to select useful information presented to the user in association with the file.

By weighting keywords according to the user evaluation, the keywords are assigned the weight that reflects the preference of the user of the portable information device. This increases the likelihood that the useful information suited to the user preference is selected.

Keywords may be weighted according to the user evaluation only when the user provides an explicit input. The user's interest in a file may not be always the same and may change with time. Therefore, it will be useful to perform the weighting operation from time to time. For example, given a situation where the same file is opened frequently, the user's interest will not change greatly over a short period of time so that the user will no longer provide an input after providing the evaluation several times. The weight of a keyword is prevented from growing too large in such a situation.

The first embodiment allows the user to evaluate the entirety of a file so that the weight commensurate with the evaluation is built up for each keyword. This relieves the burden of having to determine whether the user is interested in each keyword. By repeating the evaluation of the files, the tendency (whether the user is interested or not) in regard to the keywords will also be established gradually.

When only one type of weight is linked to each keyword such that the weight +1 is assigned when the user is interested and −1 is assigned when not, positive and negative weights are offset by each other with the result that the tendency towards keywords will not be readily seen. The first embodiment requires tallying both positive weights and negative weights. Therefore, positive and negative evaluations are not mixed with each other, and the user preference will be revealed more clearly.

The following problem will be presented by allowing the useful information selector to select useful information mapped into keywords assigned large weights. For example, when a given file is referred to repeatedly over a period of time, the weights assigned to the keywords included in the file will grow accordingly. As a result, keywords scored high as a result of weight comparison in the information selector become fixed, with the result that the same useful information continues to be displayed.

This can be addressed by allowing the keyword storage unit 110 to discount the weights stored in association with the keywords with the passage of time. For example, with the elapse of a certain period of time, the keyword storage unit 110 may discount the weights by subtracting the same value from the weights assigned to the keywords or multiplying the weights by a certain coefficient. This allows the weight that has been kept long to be discounted repeatedly with the passage of time. Consequently, the discounted keywords will carry less weight. Conversely, the weight relatively recently assigned to a keyword since the last weight discount will carry relatively heavy weight. The contribution from the weight assigned according to the user evaluation or predictor-based evaluation of a recently opened file will increase. This facilitates presentation of useful information in such a manner that recent results of evaluation make major contribution. To put it in other words, useful information more suited to the interest of the user at present is more likely to be selected by the useful information selector 150.

The keyword storage unit 110 may discount the weight linked to a keyword according to the days elapsed since the keyword was first recorded. In this case, the keyword storage unit 110 needs to be provided with a keyword registration history table that records the dates that the keywords were first registered.

As mentioned above, the function of selecting and displaying useful information and the function of weighting keywords according to the first embodiment are preferably built in the portable information device as part of the functions of operating system. Thus, by implementing the first embodiment in an operating system without using an application program, weighting can be performed for any file called from any application program executed on the operating system. Therefore, keywords can be extracted from a variety of files so that accuracy in presenting useful information that matches the user's interest is improved. However, a form of implementation, where a part of the aforementioned functional blocks is executed by another application, is not excluded.

### Second Embodiment

According to the first embodiment, an input for evaluation is received to indicate whether the user is interested in the file being opened. The weight of a keyword is adjusted according to the evaluation. In the second embodiment, the information display unit outputs a predictive evaluation score as to whether the file will be of interest to the user, prior to the user evaluation of the file. The weight of a keyword is adjusted according to the user response to the prediction result, i.e., admission or non-admission of the prediction.

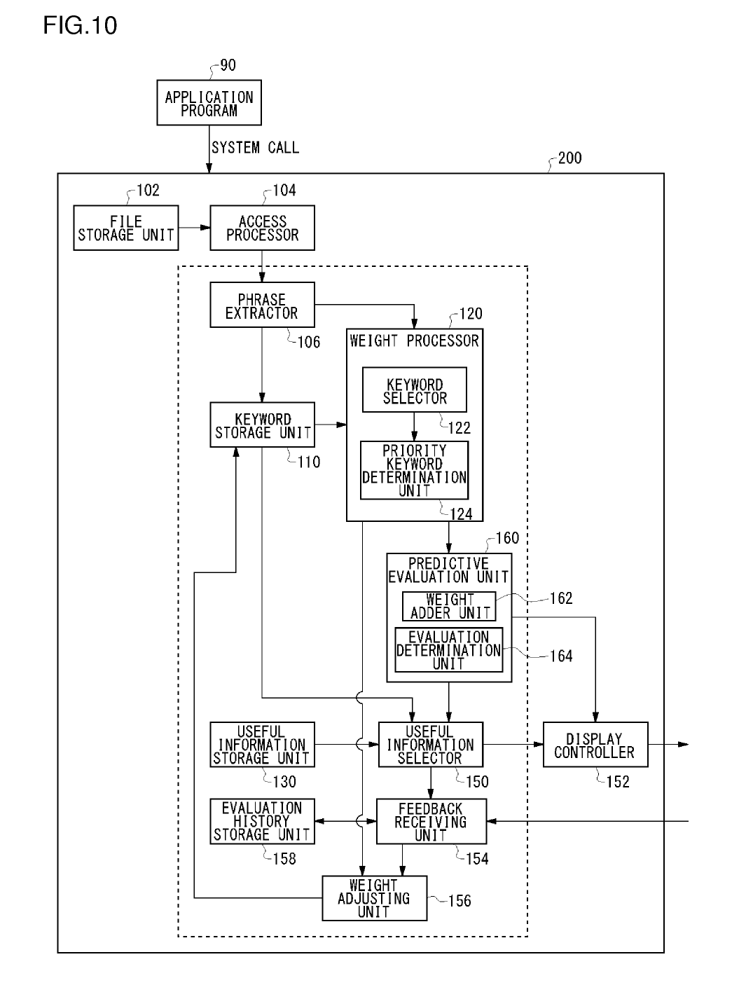

FIG. 10 shows an information display unit 200 according to the second embodiment. The functional blocks may be implemented in a variety of manners including hardware only, software only, or a combination thereof. Referring to FIG. 10, those functional blocks assigned the same numerals as the corresponding functional blocks shown in FIG. 3 have the same functions so that the description thereof is omitted.

The information display unit 200 is configured such that a predictive evaluation unit 160 is introduced between the weight processor 120 and the useful information selector 150.

The predictive evaluation unit 160 is provided with a weight adder unit 162 and an evaluation determination unit 164.

The weight adder unit 162 receives the keywords selected by the keyword selector 122 and calculates a sum of positive weights linked to each keyword and also a sum of negative weights. The evaluation determination unit 164 determines whether the user is interested in the content of a file depending on the relative magnitude of the sums of positive and negative weights. The unit 164 outputs the result of determination as a prediction result.

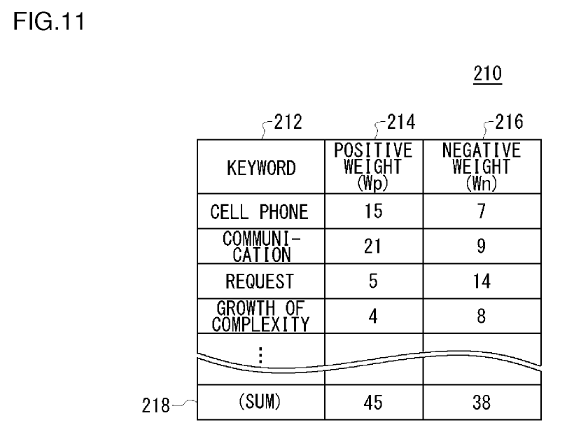

A more specific description will be given with reference to the table of FIG. 11. Referring to FIG. 11, the column 212 lists keywords selected by the keyword selector. The columns 214 and 216 list positive weights and negative weights linked to the keywords, respectively. As shown in FIG. 11, the weight adder unit 162 calculates sums 218 by adding up the positive and negative weights, respectively, for each of the keywords. The evaluation determination unit 164 compares a sum ΣWₚ of positive weights and a sum ΣWₙ of negative weights and determines the greater of the two as a predictive evaluation score of the file. In other words, when the sum of positive weights is greater, a prediction is made that the user is “Interested” in the file. When the sum of negative weights is greater, a prediction is made that the user is “Not interested” in the file.

On the display of the portable information device 10, the display controller 152 displays a mark telling the result of prediction by the predictive evaluation unit 160 to the user and also displays a mark prompting the user to respond to indicate whether the prediction result matches the user evaluation.

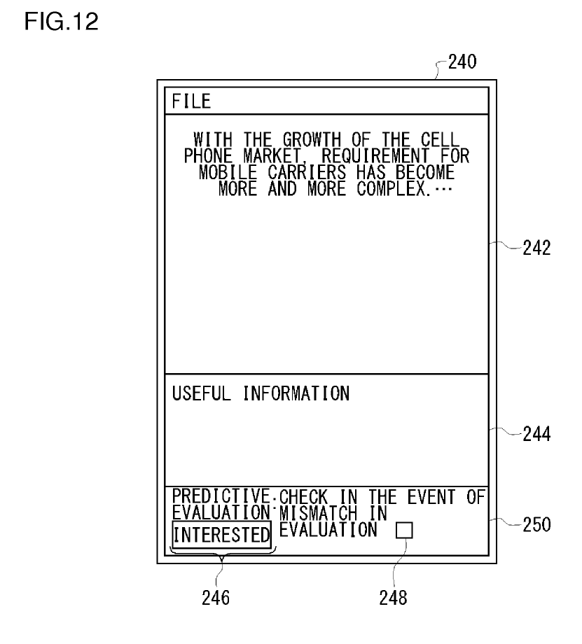

FIG. 12 shows a screen 240 where the result of prediction by the predictive evaluation unit 160 is displayed along with the application screen. The display controller 152 displays a window 250 below the window 242 for the file and the window 244 for useful information. The window 250 includes a mark 246 presenting a predictive evaluation of the file made by the predictive evaluation unit 160 and a checkbox 248 that lets the user enter a judgment of the predictive evaluation. When the prediction result and the user evaluation of the file differ, the user checks the checkbox 248. The feedback receiving unit 154 acquires the information accordingly.

When the user enters a response to the prediction result, the weight adjusting unit 156 adjusts the weight linked to the keyword according to the response.

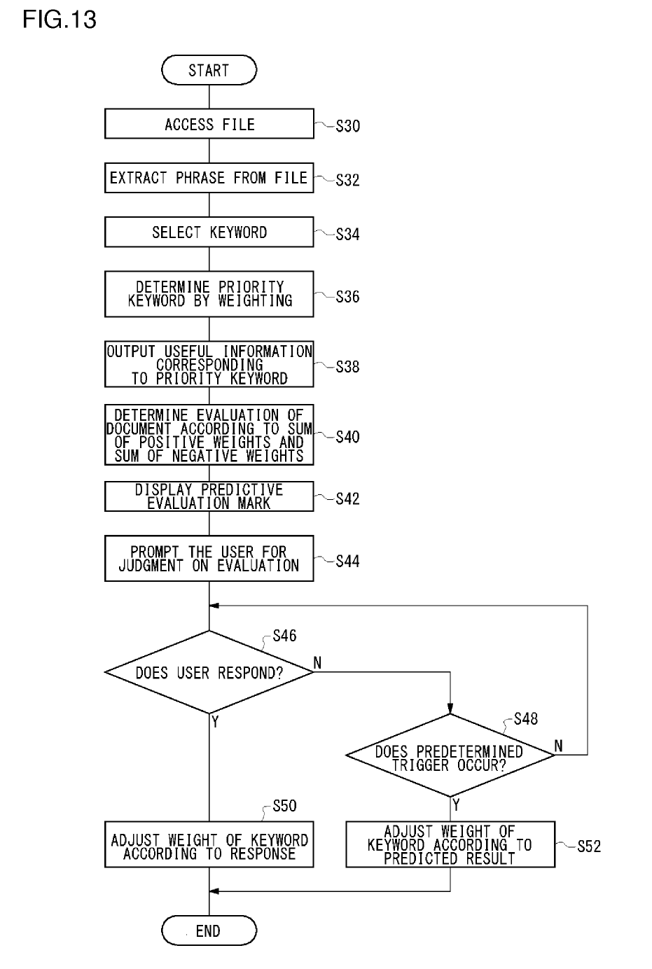

FIG. 13 is a flowchart showing the process performed in the information display unit 100 to present useful information and to weight keywords. Steps S30-S38 are the same as the steps S10-S18 of FIG. 9 so that the description thereof is omitted.

In S40, the predictive evaluation unit 160 determines the evaluation of the file according to the weight linked to a keyword. The display controller 152 displays a mark representing the prediction result (S42) and prompts the user to enter a judgment of the result (S44).

When the user provides an input (Y in S46), the feedback receiving unit 154 receives the information. The weight adjusting unit 156 refers to the input result and adjusts the positive weight or negative weight of all keywords selected by the weight processor accordingly (S50). In the example of FIG. 12, the box is checked when the prediction result differs from the user evaluation. Therefore, the user input is provided in S46 only when the prediction result made by the predictive evaluation unit 160 is in error. Thus, the weight adjusting unit 156 increments the negative weights of the keywords when the prediction result indicates that the user is “Interested”. When the prediction result indicates “Not interested”, the unit 156 increments the positive weights.

When the user does not provide an input in S46 (N in S46), the feedback receiving unit 154 determines whether a predetermined trigger occurs (S48). In the absence of a predetermined trigger (N in S48), the control is returned to S46, whereupon the device waits for an input from the user. When a predetermined trigger occurs (Y in S48), the feedback receiving unit 154 directs the weight adjusting unit 156 to adjust the weights of the keywords according to the result of prediction by the predictive evaluation unit (S52). In the absence of user input, a determination is made that the predictive evaluation matches the user evaluation so that the weights are adjusted in strict accordance with the result of prediction by the predictive evaluation unit 160. More specifically, the weight adjusting unit 156 increments the positive weights of the keywords when the prediction result indicates that the user is “Interested”. When the prediction result indicates “Not interested”, the unit 156 increments the negative weights.

As described, according to the second embodiment, the evaluation of a file is predicted according to the weights linked to the keywords, prior to the user evaluation. The user is prompted to enter a judgment as to whether the prediction result matches the user evaluation. This eliminates the need for the user to do any operation when the prediction result matches the user evaluation. Accordingly, the load imposed on the user for operation is reduced when the precision of prediction is improved.

In the second embodiment, the positive and negative weights linked to each keyword are used for two purposes, i.e., used when selecting useful information and when making predictive evaluation. By providing predictive evaluation, the user will be less likely to question the need for evaluation of the file.

Described above is an explanation based on an exemplary embodiment. The embodiment is intended to be illustrative only and it will be obvious to those skilled in the art that various modifications to constituting elements and processes could be developed and that such modifications are also within the scope of the present invention.

When the file subjected to file access is detected, by means of a certain method of detection, as being of a type for which valid user evaluation would be difficult to derive, the weight processor 120 may avoid the selection of keywords from the keyword storage unit 110.

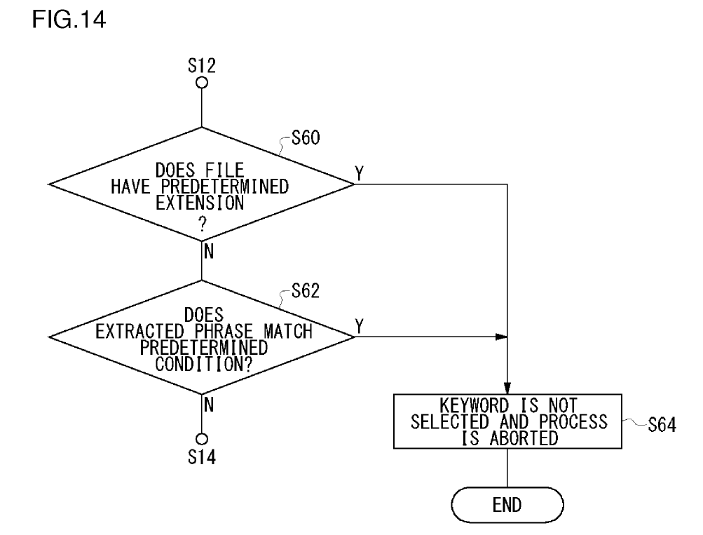

FIG. 14 is a flowchart showing this process. Following step S12 of FIG. 9, the weight processor 120 determines whether the accessed file has a predetermined extension (S60). For example, the processor 120 determines whether the extension denotes a moving image file or an audio file. When a predetermined extension is identified (Y in S60), the keyword selector 122 does not select keywords and aborts the subsequent process (S64). When the file does not have a predetermined extension (N in S60), a determination is made as to whether the phrases extracted by the phrase extractor 106 meet a predetermined condition (S62). Examples of “predetermined condition” include a case where the majority of the extracted phrases are numerals or symbols, or a case where a large number of the same phrases are extracted. When the predetermined condition is met (Y in S62), it is determined that suitable useful information cannot be selected even when the subsequent process is continued. Thus, the keyword selector 122 does not select keywords and aborts the subsequent process (S64). When the predetermined condition is not met (N in S62), the control is returned to S14 of FIG. 9, whereupon the subsequent process is continued.

The feedback receiving unit 154 may be provided with a history storage unit (not shown) that stores the history of evaluation of a file. The unit may refer to the history stored and, when the evaluation different from the past tendency of evaluation is entered by the user, display a mark prompting the user for confirmation of the evaluation.

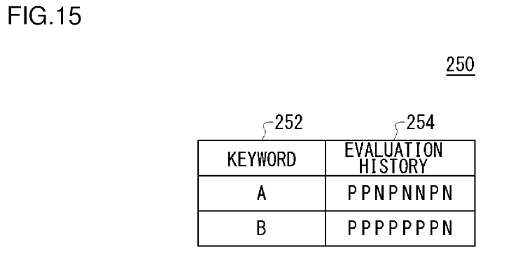

FIG. 15 shows an example of evaluation history stored in the history storage unit. A column 252 lists keywords. A column 254 lists the history of predictive evaluation made by the predictive evaluation unit or the history of evaluation entered by the user. Referring to FIG. 15, “P” denotes the evaluation “Interested” and “N” denotes the evaluation “Not interested”. When the evaluation “P” or “N” occurs consecutively a predetermined number of times or more, as in the case of the keyword B shown, or when the evaluation “P” or “N” occurs at a frequency equal to or greater than a predetermined threshold value in a predetermined number of evaluation scores provided in the past, the feedback receiving unit 154 determines whether the past tendency of evaluation matches the current evaluation. When it is determined that the past tendency of evaluation does not match the current evaluation, the feedback receiving unit 154 displays a mark prompting the user to confirm whether the evaluation currently given to the file is appropriate and a checkbox that to be checked to change the evaluation.

The weight adjusting unit 156 may be provided with a file access-based adder unit that adds up the weight defined according to the situation of access to the file in addition to the weight based on the user evaluation of the file content, i.e., the positive and negative weights mentioned above.

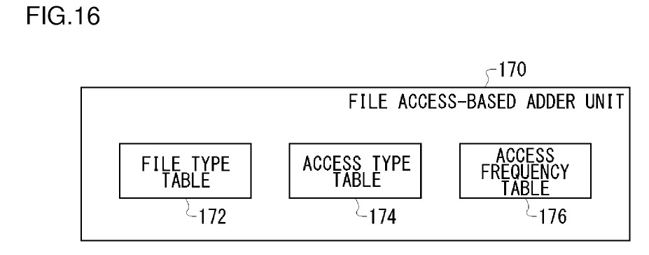

FIG. 16 is a functional block diagram showing the structure of a file access based adder unit 170. The file access-based adder unit 170 adds the weight determined by the situation of access to the file by the access processor 104 and the weight determined by the file type, to the weight linked to each of the individual keywords and acquired from the keyword storage unit 110.

In this specification, the term “situation of access” generically refers to the mode of access to the file by the access processor 104. More specifically, “access frequency” and “access type” are referred to. Access frequency is defined as a total number of times of access to each file by the access processor 104. Access type corresponds to the type of file access specified by the system call, and, more specifically, indicates opening, closing, rewriting, etc. of a file. An access situation is not restricted to these, and a weight may be set up according to access frequency so that a special weight may be assigned when, for example, a file is repeatedly accessed over a predetermined period of time.

In order to assign a weight according to access situation or file type, the file access-based adder unit 170 is provided with a plurality of tables.

A file type table 172 defines a weight for each file type. This is suitably determined according to the degree of interest to the user in the file type. For example, a weight higher than those of other files is defined according to criteria “an HTML cache file is of comparatively high interest.” When an access by the access processor 104 occurs, the file access-based adder unit 170 acquires the extension of the file so as to determine a file type and determine a weight accordingly by referring to the file type table 172.

An access type table 174 defines weights determined by the type of access by the access processor 104. It is preferable to assign a comparatively high weight to file access considered to be of high interest to the user. For example, a keyword contained in a file that is updated is considered to be of high interest to the user so that a weight higher than that of access for opening or closing is defined.

An access frequency table 176 defines a weight for each frequency of access to a file. The access frequency table 176 maintains a record of the number of times of file access for each of the files stored in the file storage unit 102. The file access-based adder unit 170 acquires the file name of a file stored in the file storage unit 102 when an access by the access processor 104 occurs, or according to a predetermined periodic schedule. Alternatively, whenever the access processor 104 accesses a file stored in the file storage unit 102, the processor 104 informs file access-based adder unit 170 of the access. The file access-based adder unit 170 increments the access frequency corresponding to the file name in the access frequency table 176, in response to information from the access processor 104.

The file access-based adder unit 170 refers to the tables 172-176, calculates a sum of weights determined by the file type, access type, and access frequency of the file accessed by the access processor 104, and adds the sum to the weight assigned to each keyword. That is, given that the weights determined by the file type, access type, and access frequency are indicated by w_{f}, wₐ, and wₜ, the increment of positive weight is indicated by Wₚ, and the previous value of the sum total of the weights is indicated by Wₙ₋₁, the weight of the keyword Wₙ is given by the following expression.

Wₙ=Wₙ₋₁+Wₚ+k(w_{f}+wₐ+wₜ) (1)

where k denotes a coefficient that helps establish a balance between the weight determined by the file access and the positive weight. The value of k may be determined by experiments or simulation so that appropriate useful information is obtained.

In the embodiments, the user provides the evaluation of the opened file only once. Alternatively, a button provided in the portable information device 10 may be assigned the function of evaluating a file so that multiple button operations of the user represent an input for incrementing the weight. Specifically, when one of the numeric buttons is assigned the evaluation “Interested”, a determination is made that the greater the number of times that the button is pressed, the greater the interest. The weight adjusting unit increments the positive weight in proportion to the number of times that the button is pressed. In this way, the contribution made by the positive weight or negative weight assigned to a keyword is canceled by pressing the button with the opposite meaning many times.

In the embodiments as described, the weight incremented for a keyword according to the user evaluation of the file is used to select useful information. However, the weight linked to a keyword may be used for other purposes. For example, the positive weight of a keyword may be used in the following exemplary applications.

### Exemplary Application 1:

The weight of a keyword is reflected in the order of displaying candidates for character-to-character conversion by a front end processor (FEP). For example, candidates for speculative character-to-character conversion from a character entered by the user are displayed such that those of the keywords stored in the keyword storage unit that can be candidates for conversion are selected and keywords linked to greater positive weights are displayed toward the top of the list. By using the positive weight linked to the keywords in this way, the hit rate of speculative conversion is improved. A similar method may be applicable to displaying candidates of conversion from a kana character to homophonic kanji characters.

### Exemplary Application 2:

The weight of a keyword is reflected in the order of displaying the result of search by a search engine.

For example, when a plurality of web sites are identified by a search engine, text information of the home page of each site is prefetched and keywords stored in the keyword storage unit are selected from the phrases extracted from the text. A sum total of the positive weights linked to the selected keywords is calculated so that web sites with larger sums are displayed toward the top of the search result.

### Exemplary Application 3:

A search result for a keyword is displayed, followed by displaying of a candidate keyword suggested as an additional search key to be entered such that keywords with greater positive weights are displayed in preference to other keywords.

The useful information selector and the useful information storage unit may be located on the side of a server accessed by the portable information device 10. The weight processor 120 determines a priority keyword by referring to the weights assigned to a plurality of keywords and then transmits the priority keyword to the server 12. The useful information selector on the side of the server 12 selects the useful information associated with the priority keyword and transmits the selected useful information to the portable information device 10. The display controller 152 receives the information thus transmitted and displays the information on the display of the portable information device 10. Thus, by locating the useful information storage unit on the server, useful information associated with keywords can be updated and added on the server side at a desired time. Therefore, the latest useful information can be presented to the user of the portable electronic device.

The inventive information display unit according to the embodiments is described as being implemented in a portable information device such as a cell phone, a PDA, a vehicle navigation device, etc. provided with data communication functions. The inventive unit may of course be implemented in desktop hardware such as a desktop PC.

### INDUSTRIAL APPLICABILITY

According to the present invention, evaluation of an opened file is fed back from the user, and the weight of a keyword for deriving useful information is adjusted accordingly.

Therefore, the likelihood of presenting useful information to the user is increased.

1. An information display device comprising:
an access processor operative to process a file access designated by a user;
a phrase extractor operative to extract a plurality of phrases from a file subjected to the file access, in accordance with a predetermined extraction rule;
a keyword storage unit operative to store a plurality of keywords, linking the keywords to weights;
a useful information storage unit operative to store a plurality of items of useful information for use by the user, in association with keywords related to the content of the information;
a weight processor operative to select, when the plurality of phrases are extracted from the file, keywords that match the plurality of phrases from the keyword storage unit and to determine a priority keyword based on the weights linked to the selected keywords;
a useful information selector operative to select the useful information associated with the priority keyword from the useful information storage unit and to display the selected information on a screen;
a feedback receiving unit operative to receive from the user an input for evaluation indicating whether user is interested in the content of the file; and
a weight adjusting unit operative to adjust the weight linked to the keyword selected by the weight processor, based on the input evaluation, and to record the adjusted weight in the keyword storage unit.

2. The information display device according to claim 1, wherein
when it is determined that the user does not provide an input for evaluation before a predetermined trigger occurs, the weight adjusting unit does not adjust the weight.

3. The information display device according to claim 1, further comprising:
a predictive evaluation unit operative to determine whether the user is interested in the content of the file, in accordance with a sum of weights linked to the keyword that matches the extracted phrase, and to output a result of prediction indicating the interest or non-interest; and
a display controller operative to display on the screen a mark that lets the user know the result of prediction by the predictive evaluation unit, wherein
the feedback receiving unit displays a mark prompting the user to respond to indicate whether the result of prediction matches the user evaluation and receives a user input in response, and
when the user provides an input in response, the weight adjusting unit adjusts the weight linked to the keyword according to the input in response.

4. The information display device according to claim 3, wherein
when it is determined that the user does not provide an input in response before a predetermined trigger occurs, the weight adjusting unit adjusts the weight linked to the keyword based on the result of prediction by the predictive evaluation unit.

5. The information display device according to claim 3 or claim 4, wherein
the keyword storage unit separately stores a positive weight and a negative weight for each keyword, the positive weight being incremented when it is determined that a positive evaluation of the content of the file is given by the user, and the negative weight being incremented when it is determined that a negative evaluation is given by the user.

6. The information display device according to claim 5, wherein
the predictive evaluation unit comprises:
a weight adder unit operative to calculate a sum of positive weights linked to each keyword that matches the phrase extracted from the file and also a sum of negative weights thus linked; and
an evaluation determination unit operative to determine whether the user is interested in the content of a file depending on the relative magnitude of the sums of positive and negative weights.

7. The information display device according to claim 5, wherein
the weight processor selects, as a priority keyword, a keyword linked to a positive weight that exceeds a negative weight.

8. The information display device according to claim 1, wherein
the keyword storage unit discounts the weights stored in association with the keywords with the passage of time.

9. The information display device according to claim 1, further comprising a history storage unit operative to store the history of user evaluation of the content of the file, wherein
the feedback receiving unit refers to the history stored in the history storage unit and, when the evaluation different from the past tendency of evaluation is entered by the user, displays a mark prompting the user for confirmation of the evaluation.

10. The information display device according to claim 1, wherein
when the file subjected to file access is detected, by means of a certain method of detection, as being of a type for which valid user evaluation would be difficult to derive, the weight processor avoids the selection of keywords from the keyword storage unit.

11. The information display device according to claim 1, wherein
the weight adjusting unit records a weight determined by the situation of access to the file by the access processor in the keyword storage unit, in addition to the weight based on the user evaluation of the content of the file.

12-13. (canceled)

14. A computer implemented information display program product comprising:
an access processing module that processes a file access designated by a user;
a phrase extracting module that extracts a plurality of phrases from a file subjected to the file access, in accordance with a predetermined extraction rule;
a weight processing module that selects, when the plurality of phrases are extracted from the file, keywords that match the plurality of phrases from a keyword storage unit, and determines a priority keyword based on the weights linked to the selected keywords, the keyword storage unit storing a plurality of keywords, linking the keywords to weights;
a useful information selecting module that selects the useful information associated with the priority keyword from a useful information storage unit and displays the selected information on a screen, the useful information selecting unit storing a plurality of items of useful information for use by the user;
a feedback receiving module that receives from the user an input for evaluation indicating whether user is interested in the content of the file; and
a weight adjusting module that adjusts the weight linked to the keyword selected by the weight processing module, based on the input evaluation, and records the adjusted weight in the keyword storage unit.

15. The computer implemented information display program product according to claim 14, wherein
when it is determined that the user does not provide an input for evaluation before a predetermined trigger occurs, the weight adjusting module does not adjust the weight.

16. The computer implemented information display program product according to claim 14, further comprising:
a predictive evaluation module operative to determine whether the user is interested in the content of the file, in accordance with a sum of weights linked to the keyword that matches the extracted phrase, and to output a result of prediction indicating the interest or non-interest; and
a display controller operative to display on the screen a mark that lets the user know the result of prediction by the predictive evaluation module, wherein
the feedback receiving module displays a mark prompting the user to respond to indicate whether the result of prediction matches the user evaluation and receives a user input in response, and
when the user provides an input in response, the weight adjusting module adjusts the weight linked to the keyword according to the input in response.

17. The computer implemented information display program product according to claim 16, wherein
the predictive evaluation module comprises:
a weight adder module operative to calculate a sum of positive weights linked to each keyword that matches the phrase extracted from the file and also a sum of negative weights thus linked; and
an evaluation determination module operative to determine whether the user is interested in the content of a file depending on the relative magnitude of the sums of positive and negative weights.

18. The computer implemented information display program product according to claim 16, wherein
the weight processor selects, as a priority keyword, a keyword linked to a positive weight that exceeds a negative weight.

19. The computer implemented information display program product according to claim 14, wherein
when it is determined that the user does not provide an input in response before a predetermined trigger occurs, the weight adjusting module adjusts the weight linked to the keyword based on the result of prediction by the predictive evaluation module.

20. The computer implemented information display program product according to claim 14 or claim 15, wherein
the keyword storage unit separately stores a positive weight and a negative weight for each keyword, the positive weight being incremented when it is determined that a positive evaluation of the content of the file is given by the user, and the negative weight being incremented when it is determined that a negative evaluation is given by the user.

21. The computer implemented information display program product according to claim 14, wherein
the keyword storage unit discounts the weights stored in association with the keywords with the passage of time.

22. The computer implemented information display program product according to claim 14, further comprising a history storage module operative to store the history of user evaluation of the content of the file, wherein
the feedback receiving module refers to the history stored in the history storage module and, when the evaluation different from the past tendency of evaluation is entered by the user, displays a mark prompting the user for confirmation of the evaluation.

23. The computer implemented information display program product according to claim 14, wherein
when the file subjected to file access is detected, by means of a certain method of detection, as being of a type for which valid user evaluation would be difficult to derive, the weight processor avoids the selection of keywords from the keyword storage unit.

24. The computer implemented information display program product according to claim 14, wherein
the weight adjusting module records a weight determined by the situation of access to the file by the access processor in the keyword storage unit, in addition to the weight based on the user evaluation of the content of the file.

25. A server-client information display system for displaying useful information in a client terminal, comprising a client terminal and a server,
the client terminal comprising:
an access processor operative to process a file access designated by a user;
a phrase extractor operative to extract a plurality of phrases from a file subjected to the file access, in accordance with a predetermined extraction rule;
a keyword storage unit operative to store a plurality of keywords, linking the keywords to weights;
a weight processor operative to select, when the plurality of phrases are extracted from the file, keywords that match the plurality of phrases from the keyword storage unit and to determine a priority keyword based on the weights linked to the selected keywords;
a feedback receiving unit operative to receive from the user an input for evaluation indicating whether user is interested in the content of the file; and
a weight adjusting unit operative to adjust the weight linked to the keyword selected by the weight processor, based on the input evaluation, and to record the adjusted weight in the keyword storage unit, and
the server comprising:
a useful information storage unit operative to store a plurality of items of useful information for use by the user, in association with keywords related to the content of the information; and
a useful information selector operative to receive the priority keyword from the client terminal, to select the useful information associated with the priority keyword, and to transmit the selected information to the client terminal.

26. The server-client information display system according to claim 25, wherein
when it is determined that the user does not provide an input for evaluation before a predetermined trigger occurs, the weight adjusting unit does not adjust the weight.

27. The server-client information display system according to claim 25, the client terminal further comprising:
a predictive evaluation unit operative to determine whether the user is interested in the content of the file, in accordance with a sum of weights linked to the keyword that matches the extracted phrase, and to output a result of prediction indicating the interest or non-interest; and
a display controller operative to display on the screen a mark that lets the user know the result of prediction by the predictive evaluation unit, wherein
the feedback receiving unit displays a mark prompting the user to respond to indicate whether the result of prediction matches the user evaluation and receives a user input in response, and
when the user provides an input in response, the weight adjusting unit adjusts the weight linked to the keyword according to the input in response.

28. The server-client information display system according to claim 27, wherein
the predictive evaluation unit comprises:
a weight adder unit operative to calculate a sum of positive weights linked to each keyword that matches the phrase extracted from the file and also a sum of negative weights thus linked; and
an evaluation determination unit operative to determine whether the user is interested in the content of a file depending on the relative magnitude of the sums of positive and negative weights.

29. The server-client information display system according to claim 27, wherein
the weight processor selects, as a priority keyword, a keyword linked to a positive weight that exceeds a negative weight.

30. The server-client information display system according to claim 25, wherein
when it is determined that the user does not provide an input in response before a predetermined trigger occurs, the weight adjusting unit adjusts the weight linked to the keyword based on the result of prediction by the predictive evaluation unit.

31. The server-client information display system according to claim 25 or claim 26, wherein
the keyword storage unit separately stores a positive weight and a negative weight for each keyword, the positive weight being incremented when it is determined that a positive evaluation of the content of the file is given by the user, and the negative weight being incremented when it is determined that a negative evaluation is given by the user.

32. The server-client information display system according to claim 25, wherein
the keyword storage unit discounts the weights stored in association with the keywords with the passage of time.

33. The server-client information display system according to claim 25, the client terminal further comprising a history storage unit operative to store the history of user evaluation of the content of the file, wherein
the feedback receiving unit refers to the history stored in the history storage unit and, when the evaluation different from the past tendency of evaluation is entered by the user, displays a mark prompting the user for confirmation of the evaluation.

34. The server-client information display system according to claim 25, wherein
when the file subjected to file access is detected, by means of a certain method of detection, as being of a type for which valid user evaluation would be difficult to derive, the weight processor avoids the selection of keywords from the keyword storage unit.

35. The server-client information display system according to claim 25, wherein
the weight adjusting unit records a weight determined by the situation of access to the file by the access processor in the keyword storage unit, in addition to the weight based on the user evaluation of the content of the file.
